(19) United States
(12) Patent Application Publication
(10) Pub. No.: US 2012/0143646 A1
(43) Pub. Date: Jun. 7, 2012

(54) Method and system for management of mobilization data

(76) Inventor: Stephen Mark Allen, Peachtree City, GA (US)

(21) Appl. No.: 12/927,987

(22) Filed: Dec. 1, 2010

(51) Int. Cl. G06Q 10/00

(52) U.S. Cl. 705/7.25

(57) ABSTRACT

Disclosed is a system to provide for the accessing, organizing, and management of various sources of data pertinent to the mobilization of military forces. The system accesses data available from the Joint Chiefs of Staff, Joint Forces Command, Special Operations Command, Transportation Command, and Strategic Command and enters all current collected data into a common data management system entitled “COLOSSUS. The collected data is re-formatted and stored on commercially-available software, whereby it is made accessible to an end User, who must possess authorized security clearance. The information stored in the COLOSSUS system is used in conjunction with the mobilization, training, validation, deployment, and demobilization of military reserve component units of any numbered U.S. field army. COLOSSUS is also applicable to mobilization and/or deployment of forces of all other branches of the U.S. Military.

### CROSS-REFERENCES TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

(1) Field of the Invention

The disclosures herein relate to the technical field of data management, and more particularly, the management of various sources of data pertinent to the mobilization of military units. Within the United States armed forces, each level of command and each branch of the military maintains data on unit and individual requirements that may be required in support of military operations. This process starts with the requesting Combatant Commander submitting their unit and individual requirements to the Joint Chiefs of Staff. The Joint Staff then disseminates these requirements to its Joint Force Providers (Joint Forces Command, Special Operations Command, and Transportation Command).

The Joint Force Providers further disseminate these requirements to their assigned Service Component Commands. When the Service Component Commands fill these requirements, they enter that data into their own data management system. This data is forwarded to the respective Joint Force Provider where it is entered into their (another, distinctively different) data management system. When these unit and individual recommendations are approved by the appropriate authority, then that data is entered into the Joint Staff data management system.

Some of these aforementioned data management system are autonomous from the others, as they were built to meet that particular command's information needs. A glaring result is that there is no standard naming convention for the various data fields. A second related result is that there may be difference in the data among the different data management systems.

Since the data is used in function concerning the mobilization, training, validation, and deployment of military reserve component units, having current, accurate and readily accessible data is vital in the execution of those functions. To obtain and correlate all the various data discussed above, an analyst would need to log into each data management system, query for that data, then find a means to consolidate that data to conduct his/her analysis.

(2) Description of Related Art, Including Information Disclosed Under 37 CFR 1.97 and 1.98.

In U.S. Pat. No. 7,793,221(2010) the disclosed invention features a system for providing administrative support for a military unit. The invention includes a server-side database containing information about the military unit and a client-side browser application that provides a secure network connection to the database. Unit members can access the application to retrieve and edit the administrative information, wherein unit members can access administrative information specific to their respective responsibilities.

An invention disclosing an integrated method and system for managing human resources is disclosed in U.S. Pat. No. 7,778,180 (2010). Specifically, the method and system integrates processes for developing (1) a strategy for drafting a set of rules on how human resources will be managed and sourced; a long-term strategic plan for sourcing human resources to satisfy demands; a near-term operational plan recommending individual human resources be used to satisfy selected demands; and a process for selecting and assigning individual resources to specific engagements.

In U.S. Pat. No. 7,672,746 (2010) systems and methods are disclosed for scheduling overtime and time-off for a workforce. In one embodiment, the method comprises: receiving a workforce schedule including assignments of workers to shifts; receiving a template describing alterations to shifts; and applying schedulable objects to the workforce schedule in accordance with a workload forecast and schedule constraints.

U.S. Pat. No. 7,508,537 (2009) is a computerized system where one or more parameters, such as time, are reported to a center using a form. The center then automatically extracts data from the form and converts it for storage and subsequent processing or review. The form is preferably a tangible form, which the sender completes, and then faxes or emails to the center. Image capture, registration, and feature recognition routines are included to enable the center to extract the reported data with no need for data reentry or human intervention.

A system and method for assisting in planning a mission on a plurality of targets with a plurality of resources of different types is disclosed in US patent application publication #2007/0299711 (2007). Information about a mission, the targets and the resources are received. The system includes a plurality of computing modules arranged in a hierarchical structure comprising at least two levels. The primary level includes a plurality of computing modules, each corresponding to one or more resources of a specific type and arranged for producing a cost estimate for performing the mission by means of those resources, based on a mathematical model of the resource and data on the mission, the targets, and the resources.

U.S. Pat. No. 5,583,976 (1996) is an invention featuring processes and devices for improving data management and reallocation in intelligent networks. Such processes and devices provide intuitive representation of models of data stored in network elements so that system Users may more efficiently and reliably reallocate applications and data resources among the network elements.

### BRIEF SUMMARY OF THE INVENTION

The inventive concept presented herein is a system and method comprising a multi-step process that starts with downloading raw data from several mobilization data sources; formatting, screening, and manipulating that data, and then making that data available through a Graphic User Interface (GUI) which utilizes one of the several commercially available software formats.

In summation, the multiple steps required are:

1. Download the raw data from each data source;

2. For each data source, use spreadsheet software, such as Microsoft Excel, to reformat the data into standardized format that is recognizable by Microsoft Access database;

3. For each data source, use Microsoft Access, or similar software, to manipulate the reformatted data, specifically to screen the data for errors and to select the most current, actionable data for command and staff consideration; and

4. Integrate the data from each of the accessed databases into a single Microsoft Access database program (or similar software) and provide this data in standardized formats tailored to the customer's (end User's) requirements.

This system of managing military mobilization data will be referred to for convenience within this presentation, as “COLOSSUS.” COLOSSUS is also referred to as the Master Database. As further simplification of the overall inventive concept, the system and procedures disclosed herein will be predicated on a hypothetical mobilization within the United States First Army. The disclosures herein are fully applicable to the mobilization and operational function of any numbered U.S. Field Army. Therefore, the disclosures thus presented are to be given consideration not by way of limitation of the effectiveness and applicability of the inventive concept, but strictly for convenience and illustrative purposes.

### BRIEF DESCRIPTION OF THE VIEWS OF THE DRAWINGS

FIG. 1 presents a diagram of the current method normally used to search for data pertinent to mobilization of a field army.

FIG. 2 outlines the more efficient method of searching for data relevant to a mobilization, utilizing the COLOSSUS software program.

FIG. 3 shows a presentation of the various formatted information available for command and staff decisions.

FIG. 4 depicts the sources of raw data utilized by COLOSSUS, including the military level from which the data is obtained.

FIG. 5 illustrates the flow process by which COLOSSUS obtains data from the Joint Chiefs of Staff website to format and process same into the GFMAP Database.

FIG. 6 depicts the sequence by which data from the JFCOM and JCRM websites is downloaded, formatted, and integrated into their respective databases.

FIG. 7 illustrates the flow pattern by which data from the MDIS website is downloaded and formatted so as to comprise the MDIS database.

FIG. 8 illustrates the flow pattern by which data from the AST website is downloaded and formatted so as to comprise the AST database.

FIG. 9 is a chart illustrating the methodology for creating the FTN and UIC Analysis Data Tables

FIG. 10 shows the screen presented when a User accesses the Master Database, or “Manager's Program.”

FIG. 11 shows the computer window which is opened when “FTN Analysis” is selected on the Manager's Program screen.

FIG. 12 illustrates page 1 of the computer window which is opened when “UIC Analysis” is selected on the COLOSSUS Manager's Program.

FIG. 13 illustrates page 2 of the computer window which is opened when “UIC Analysis” is selected on the COLOSSUS Manager's Program.

FIG. 14 illustrates page 3 of the computer window which is opened when “UIC Analysis” is selected on the COLOSSUS Manager's Program.

FIG. 15 presents the computer window which is opened when “Joint Assessment Switchboard” is selected on the COLOSSUS Manager's Program.

FIG. 16 shows the Unit List Filter for a COLOSSUS-generated Joint Assessment Roster

FIG. 17 presents a COLOSSUS-generated computer window displaying a form for the initial review of a Joint Assessment Roster.

FIG. 18 illustrates a computer window displaying the initial input form for a Component-generated Joint Assessment Roster.

FIG. 19 presents a Component-generated computer window displaying a form for the initial review of a Joint Assessment Roster.

FIG. 20 shows a computer window displaying a form for adding a new requirement to an existing Joint Assessment Roster.

FIG. 21 displays a computer window opened to display selections for the Joint Assessment Master Roster.

FIG. 22 displays the information presented when the Sign-in Roster selection is made from the Joint Assessment Switchboard.

FIG. 23 illustrates the data input and windows displayed when the classified PMTT Worksheet selection is made from the Joint Assessment Switchboard page.

FIG. 24 displays the data input, information and windows presented when the unclassified PMTT Worksheet selection is made from the Joint Assessment Switchboard page.

FIG. 25 illustrates a computer window displaying entries for the Joint Assessment Outbrief Roster.

FIG. 26 displays the inputs available on the home page of a Customer Database (Customer's Program).

### SUMMARY OF NOMENCLATURE FOR ACRONYMS AND COMPONENTS

AAD: Actual Arrival Date (AAD): The confirmed date of arrival of a military unit or an individual at its (his/her) duty station.

ASL: Army Sourcing Laydown (ASL) is a spreadsheet that depicts FORSCOM assigned units that have been sourced against a requirement.

ARFORGEN: Army Force Generation, is a process in which the U.S. Army identifies which units will fulfill operational requirements over a multi-year period, in order to schedule breaks between deployments.

AST: ARFORGEN Synchronization Toolset is one of several web-based external data sources where mobilization data may be downloaded. The AST is maintained at Forces Command (FORSCOM). A product of the AST is the Army Sourcing Laydown (see above).

BOS: Battlefield Operating System (BOS) is an outdated term that signified the grouping of like force capabilities. The seven Battlefield Operating Systems are the major functions that occur on the battlefield (Intelligence, Maneuver, Fire Support, Air Defense, Mobility and Survivability, Combat Service Support, and Command & Control.

CENTCOM: Central Command, which is one of six geographic Combatant Commands (COCOM). CENTCOM's area of responsibility is in the Middle East, including Egypt, and Central Asia. CENTCOM has been the main American presence in many military operations, including the Gulf War, the United States war in Afghanistan, and the Iraq War. Geographic Combatant Commands such as CENTCOM are also referred to as supported commands because all other “supporting” commands provide support (e.g., units) to the Geographic Combatant Commands. Since almost all combatant operations are currently occurring in CENTCOM's area of responsibility, the method disclosed herein follows CENTCOM's “business rules” in regards to the length of time an individual or a unit spends in their area of operations.

COCOM: Combatant Command (command authority). COCOM is a concept that cannot be delegated. It is the authority of a combatant commander to perform those functions of command over assigned forces involving organizing and employing commands and forces, assigning tasks, designating objectives, and giving authoritative direction over all aspects of military operations, joint training, and logistics necessary to accomplish the missions assigned to the command.

COMPONENT PLANNING: There are three components to the U.S. Army, which are identified as Active Component, Army Reserve, and Army National Guard. In the context of this inventive concept, Component Planning means that any of these three components can engage in planning in preparation for the Joint Assessment.

DAMPS Department of the Army Mobilization Processing System: DAMPS is a web-based Command and Control application that assists the US Army in automating mobilization operations. DAMPS provides mobilization data on both military units and individuals.

FIRST ARMY: One of the United States Field Armies, comprising an East Division and a West Division. The two divisions combined have nine infantry brigades, three field artillery brigades, two armored brigades, one cavalry brigade, and one aviation brigade. The First Army is responsible for mobilizing, training, validating, and deploying Reserve Component (Army Reserve and Army National Guard) units in accordance with Combatant Commander, Department of the Army, and/or FORSCOM directives.

FOUO: For Official Use Only.

FTN Analysis: A generically-provided name applicable to one of the features utilized in this inventive concept, and comprises one of several, unique tools that are built into COLOSSUS. FTN Analysis consolidates all external data and can provide a historical, current, and future timeline of requirements data.

FTN: Force Tracking Number. An eleven character alpha-numeric reference number assigned by a supported Combatant Commander which represents a single force or capability. The FTN is used to uniquely identify, organize, and manage force or capability requirements.

FTN Line Number: This number uniquely identifies each part of the sourcing solution for an FTN. This can be either a single sourcing solution for the FTN (e.g., a single unit in which case the FTN Line Number is 1); multiple rotations within the same fiscal year for that FTN (e.g., a unit deploys in October 2009 in which case the FTN Line Number is 1 with a follow-on unit that replaces the first unit and deploys in July 2010 in which case the FTN Line Number is 2), or multiple sourcing solutions for that FTN (e.g., the Navy provides 50% of the sourcing solution in which case the FTN Line Number is 1 and the Army provides the other 50% of the sourcing solution in which case the FTN Line Number is 2).

GFMAP: Global Force Management Allocation Plan. This is one of several web-based external data sources from which mobilization data may be downloaded. The GFMAP is maintained at the office of the Chairman of the Joint Chiefs of Staff

HOLISTIC: A paraphrased name which emphasizes the quality of the inventive concept The term is akin to or concerned with wholes or with complete systems rather than with the analysis of, treatment of, or dissection into, parts. COLOSSUS is designed to provide the most complete picture of a military mobilization requirement than can be found anywhere else.

JCRM MISMATCHES: An original term applicable to this inventive concept. When there are differences in the data between the JCRM database and the MDIS and/or AST databases, they are referred to as mismatches. This usually happens when there is an update to the MDIS or AST database and those updates are not passed up to the JCRM database.

JFCOM: the Joint Forces Command

JOINT ASSESSMENT PROCESS: A First Army-specific process where proactive planning is initiated with Army Reserve and Army National Guard units that are going to mobilize and deploy overseas. It is during this process where a timeline is established and responsibilities are delineated with regards to First Army's mission of mobilizing, training, validating, and deploying Reserve Component units

LAD: Latest Arrival Date (LAD). This is date when a unit is required to arrive in theater.

MDIS: Mobilization and Deployment Information System (MDIS). One of several web-based external data sources where mobilization data may be downloaded. The MDIS is maintained at the Department of the Army level.

MOB Synch Boards: Mobilization Synch Boards. A First Army hosted meeting conducted weekly via Video Teleconferencing for the purpose of mobilization coordination. This is typically done for units that have already completed a Joint Assessment and serves to refine their mobilization timeline.

MOBILIZATION CALCULATOR: The name provided for one of the several tools that are built into COLOSSUS. There are several mobilization calculators available within the military. However, as applicable to this inventive concept, the process used to populate the Mobilization Calculator is unique. Embedded in the UIC Analysis Tool, the Mobilization Calculator takes data from a unit currently deployed and, based on the CENTCOM Business Rules, projects the mobilization date and Latest Arrival Date (LAD) for another unit that has been identified to replace the deployed unit.

MOD: Represents a change (or modification) to a requirement. The highest number represents the latest change (e.g., MOD 2 is higher than MOD 1) and the highest MOD supersedes all previous MODS to include the original requirement. COLOSSUS looks only at the current requirement based on the MOD.

MOB DATE CALCULATOR: Same as Mobilization Calculator (see above).

MOB/DEMOB STATION: Mobilization and Demobilization Stations. This term designates specific locations where units go to mobilize or demobilize. COLOSSUS looks at this data and standardizes it, correcting misspellings, etc.

PMTT WORKSHEET: Post Mobilization Training Timeline, or the name provided for one of the several worksheet tools that are built into COLOSSUS. A previous version of the PMTT worksheet existed prior to the implementation of this inventive concept, so PMTT is not necessarily unique in this disclosure. However, the current inventive concept significantly improves the process in which this form was previously utilized, thereby rendering it a more powerful/useful tool. Based on coordination done during the Joint Assessment, the PMTT Worksheet is populated to determine a Unit's LAD, Mobilization Date, and Mobilization Station Arrival Date.

REC ID: A unique number used in MDIS to distinguish a requirement. The REC ID is used in MDIS as an FTN Line Number is used in JCRM, however, these numbers do not match.

SAMAS: Structure And Manpower Allocation System is a Department of the Army (DA) system for maintaining force structure actions (e.g., units, strength numbers, etc)

SIPR LAN: Secure Internet Protocol Routing Local Area Network (SIPR LAN). This is the classified (Secret) computer-based LAN in which the COLOSSUS functions are performed. In regards to COLOSSUS it requires that COLOSSUS be defined as classified (Secret) program.

SOF ANNEX: Special Operation Forces are provided by the Special Operations Command. This term is descriptive of a list of approved Special Forces requirements found in the GFMAP.

SWITCHBOARDS: A programmer term, which in the case of this inventive concept, a form that allows a User to go to multiple other forms.

TOOLS: The name provided to the User capabilities found in COLOSSUS.

TRAINING TEMPLATE: First Army subordinate units (Division East at Fort Meade, MD and Division West at Fort Hood, Tex.) maintain their own slides for their respective mobilization planning, which are referred to as training templates.

UIC: Unit Identification Code is a six character, alphanumeric code that uniquely identifies each Active, Reserve, and National Guard unit of the U.S. Armed Forces. Active Component=1, Army National Guard=2, and the Army Reserve=3

UIC ANALYSIS: A generically-provided name applicable to one of the features utilized in this inventive concept, and comprises one of several, unique tools that are built into COLOSSUS. UIC Analysis combines all “like” data and provides a snapshot in time of a specific requirement.

UIC (Bad): An event wherein COLOSSUS can identify bad UICs when they are 7 or more digits in length. This typically occurs as typos when they are manually entered into a data system.

### DETAILED DESCRIPTION OF THE INVENTIVE CONCEPT

The core of COLOSSUS is the process of pulling, screening, and comparing mobilization data from multiple sources, identifying errors, and selecting the most current actionable data for command and staff consideration. The ultimate objective is to provide the most comprehensive and accurate picture of, by way of example, the First Army 8 unit requirements for mobilization, training, and deployment. To describe the functions of COLOSSUS, continuing reference to the Figures including in this disclosure will be made.

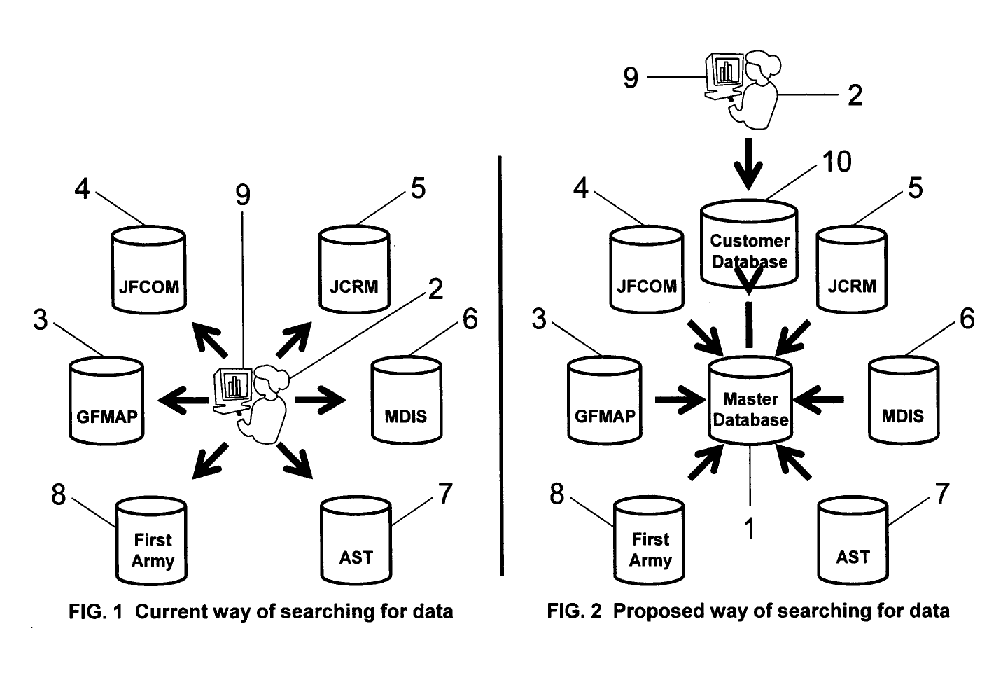

In FIG. 1, a single User 2 at a desktop computer 9 is shown inputting search parameters, one at a time, into the online data bases of GFMAP 3, JFCOM 4, JCRM 5, MDIS 6, AST 7, and FIRST ARMY 8, as a preliminary step in compiling necessary raw data which is critical to a planned mobilization or deployment. In FIG. 2, the User 2 is shown accessing a Customer Database 10 specifically customized for the User's 2 unit, from a Master Database 1. The Master Database 1 is compilation of various groupings of raw data, which has previously been acquired and formatted by the COLOSSUS software. The formatting of this raw data is arranged in computer-based forms to allow a User 2 to access all data relevant to a planned mobilization or deployment.

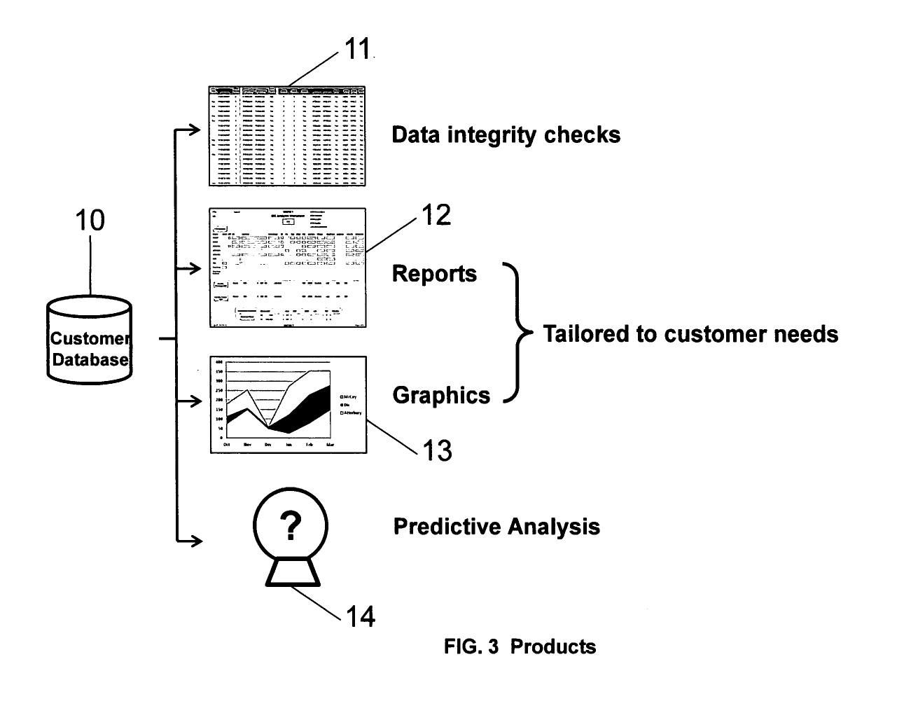

FIG. 3 presents a table of generalized information which is available upon the User 2 logging into the Customer Database 10. Information available includes data integrity checks 11, specialized reports 12, customized graphics 13, and predictive analyses 14, all of which are tailored to the User's 2 command and staff needs.

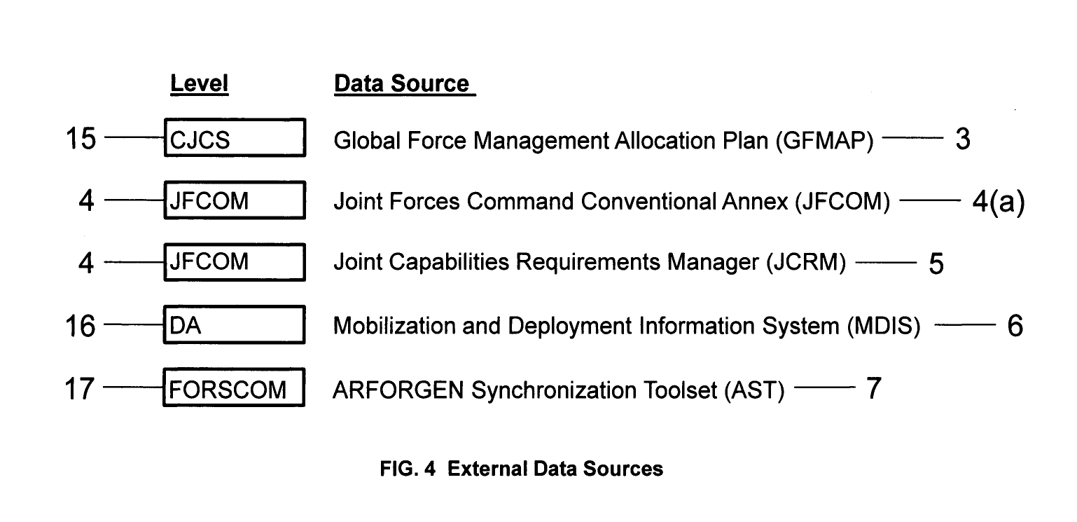

FIG. 4 illustrates the corresponding level of acquisition and composition of the sources of external data necessary to properly assess the requirements of a unit mobilization or deployment. These include the Chairman of the Joint Chief of Staff 15, which is the source of the Global Management Allocation Plan, or GFMAP 3; the Joint Forces Command, or JFCOM 4, which is the source of both JFCOM Conventional Annex 4(a) and the Joint Capabilities Requirements Manager, JCRM 5; the Department of the Army (DA) 16, which is the source of the Mobilization and Deployment Information System, MDIS 6, and Forces Command, or FORSCOM 17, the source of the Army Force Generation (ARFORGEN) Synchronization Toolset, or AST 7.

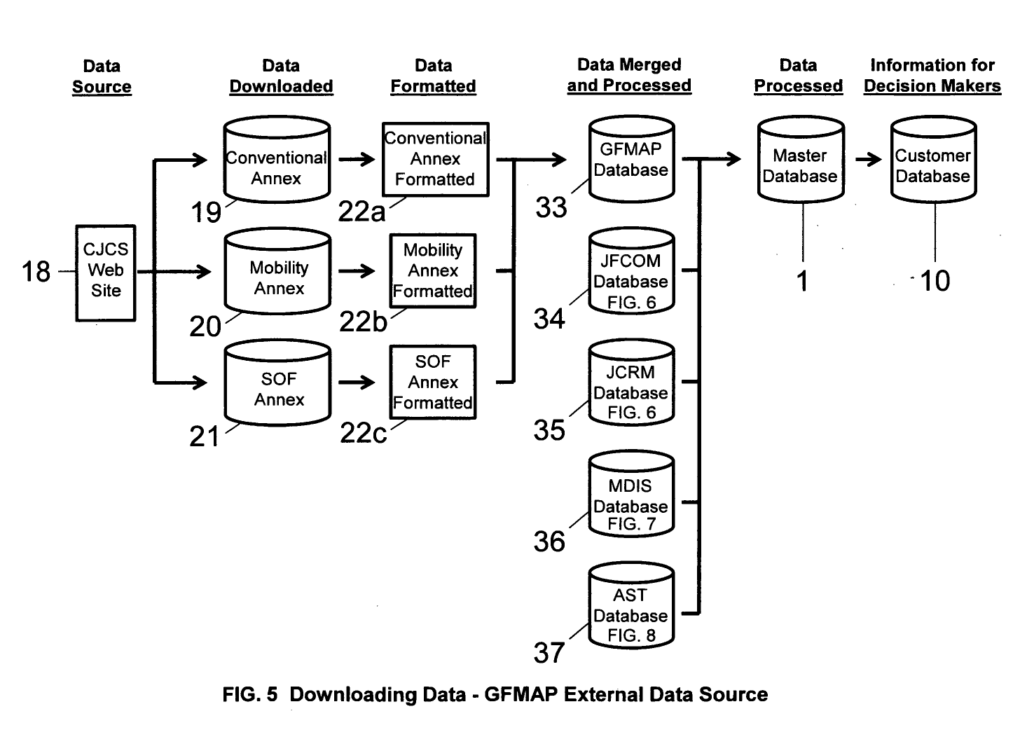

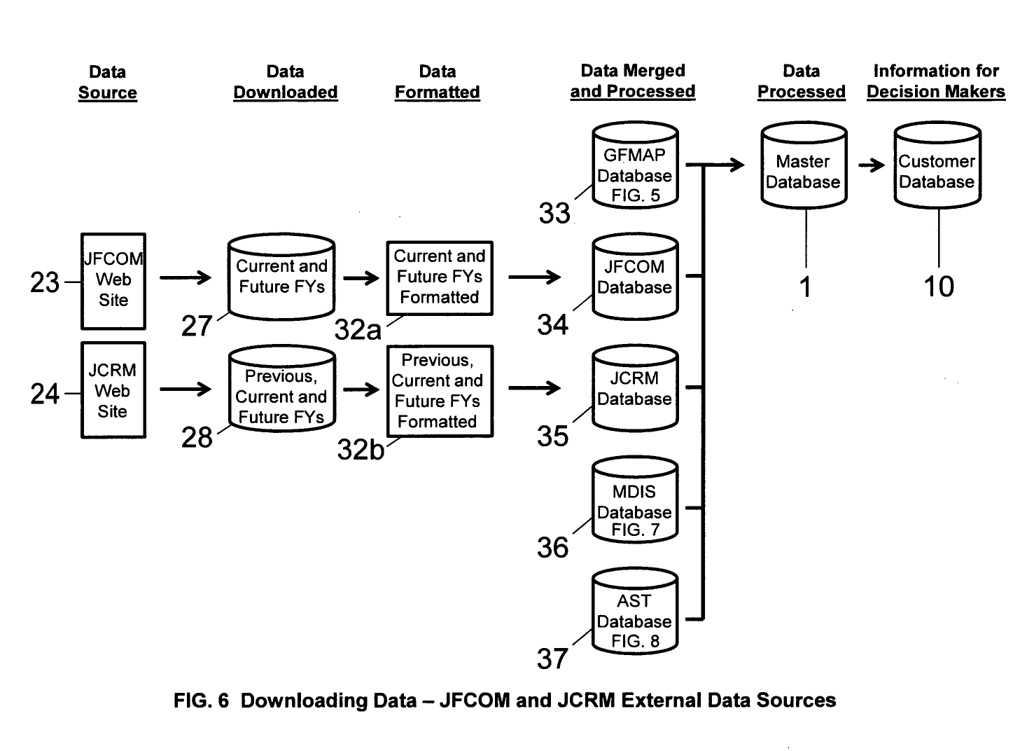

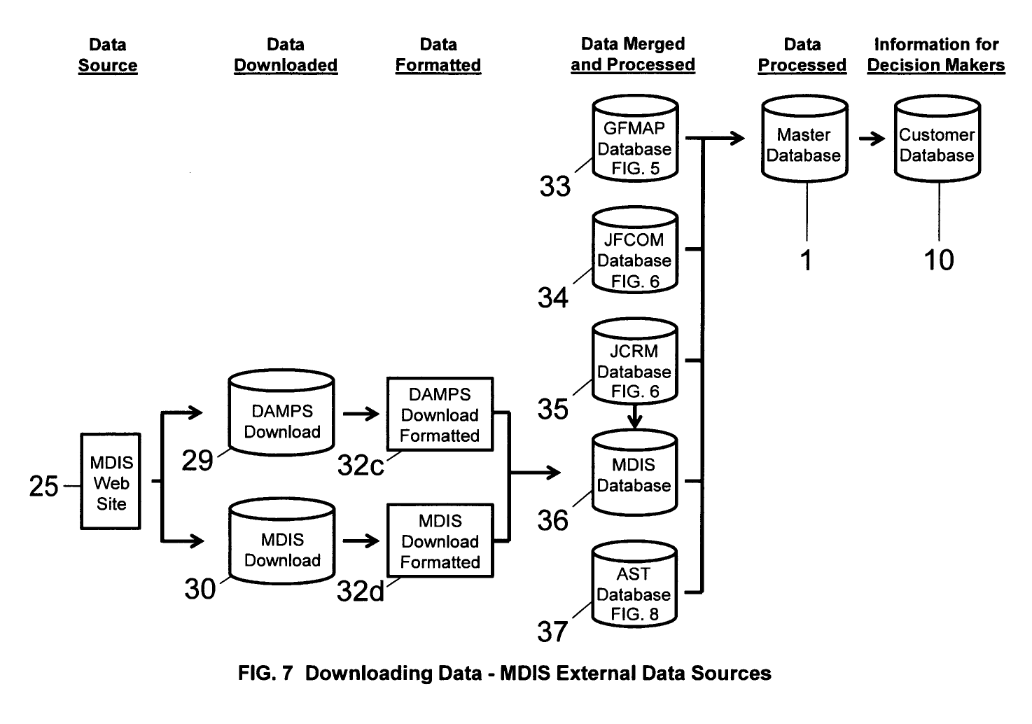

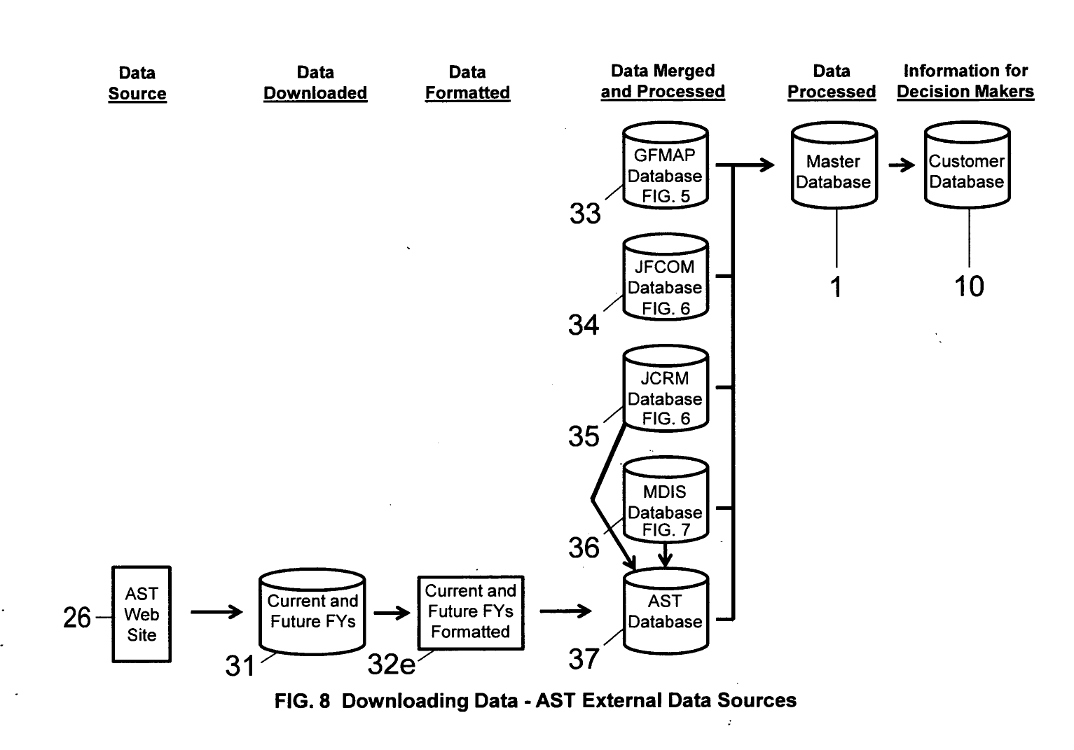

FIG. 5 depicts the process wherein first, the CJCS website 18 is accessed and mobilization data from the GFMAP 3, comprising three forms of data: conventional annex 19, mobility annex 20, and special operations forces annex (referred to as SOF Annex) 21, are downloaded. These three forms of data are entered into macro driven spreadsheets that will change the three forms into Conventional Annex Formatted 22(a), Mobility Annex Formatted 22(b), and SOF Annex Formatted 22(c). This enables the reading of the formatted data by a database program; specifically the FTN is converted into a text data field. These three forms of formatted data 22(a), 22(b), and 22(c) are linked to a GFMAP Database 33 where they are first merged into a single accumulated set of data and then the GFMAP Database 33 processes this data and selects the most current requirements, for each FTN and FTN Line Number, based on their MOD. As will be explained shortly, COLOSSUS will concurrently compile a JFCOM Database 34, a JCRM Database 35, an MDIS Database 36, and an AST Database 37. All the aforementioned databases are linked to the Master Database 1, where they are merged into two sets of data called FTN Analysis and UIC Analysis, respectively. From the Master Database 1, a specific military unit's requirements may be compiled and derivatively programmed to arrive at a Customer Database 10.

Turning to FIG. 6, a similar process is observed wherein COLOSSUS is used to access various military websites for obtaining data relevant to a mobilization or deployment. The JFCOM website 23 is accessed to acquire data of current and future fiscal years 27, which is then formatted and merged into a compilation of all JFCOM fiscal years 32a, and subsequently linked to a JFCOM Database 34 that processes this data and selects the most current requirements, for each FTN and FTN Line Number, based on their MOD. Similarly, the JCRM website 24 is accessed to acquire data of previous, current, and future fiscal years 28, which is then formatted and merged into a compilation of all JCRM fiscal years 32b, and subsequently linked to a JCRM Database 35 that processes this data and selects the most current requirements, for each FTN and FTN Line Number, based on their MOD. The content of the JFCOM database 34 and the JCRM database 35 are then processed into the Master Database 1, along with other database (33, 36, and 37) inputs.

FIG. 7 depicts the process wherein first, the MDIS website 25 is accessed and mobilization data from the MDIS 6, comprising two forms of data: DAMPS data 29, and MDIS data 30, are downloaded. These two forms of data are entered into macro driven spreadsheets that will change the two forms of data into DAMPS Download Formatted 32c, and MIDIS Download Formatted 32d. This enables the reading of the formatted data by a database program; specifically the FTN is converted into a text data field. These two forms of formatted data 32c, and 32d are linked to a MDIS Database 36 where they are merged into a single accumulated set of data. Because MDIS data does not have an FTN Line Number the MIDIS Database 36 assigns an FTN Line Number based on several comparisons with data found in the JCRM Database 35. This is accomplished by taking data from both the JCRM Database 35 and the MDIS database 36 that have the same FTN and comparing their unit UICs and LADs. MDIS FTNs that closely match an JCRM FTN are then assigned that JCRM FTN Line Number. MDIS FTNs that do match any of the JCRM FTNs are assigned an FTN Line Number of 0 to indicate that this a requirement that was not found in the JCRM Database 35. The content of the MDIS database 36 is then processed into the Master Database 1, along with other database (33, 34, 35, and 37) inputs.

FIG. 8 depicts the process wherein first, the AST website 26 is accessed to acquire data of current and future fiscal years 31, which is then formatted and merged into a compilation of all AST fiscal years 32e, This data 32e, is linked to a AST Database 37. Because AST data does not have an FTN Line Number the AST Database 37 assigns an FTN Line Number based on several comparisons with data found in both the JCRM Database 35 and the MDIS Database 36. This is accomplished by taking data from both the JCRM Database 35, the MDIS database 36 and the AST Database 37 that have the same FTN and comparing their unit UICs and LADs. This is done by comparing AST FTNs against JCRM FTNs first, and then against MDIS FTNs. AST FTNs that closely match a JCRM FTN found in the JCRM Database 35 are then assigned that JCRM FTN Line Number. AST FTNs that do not match a JCRM FTN are then matched against MDIS FTNs. AST FTNs that closely match an MDIS FTN found in the MDIS Database 36 are then assigned that MDIS FTN Line Number. AST FTNs that do match any of the JCRM or MDIS FTNs are assigned and FTN Line Number of 0 to indicate that this is a requirement that was not found in either the JCRM Database 35 or the MDIS Database 36. The content of the AST database 37 is then processed into the Master Database 1, along with other database (33, 34, 35, and 36) inputs.

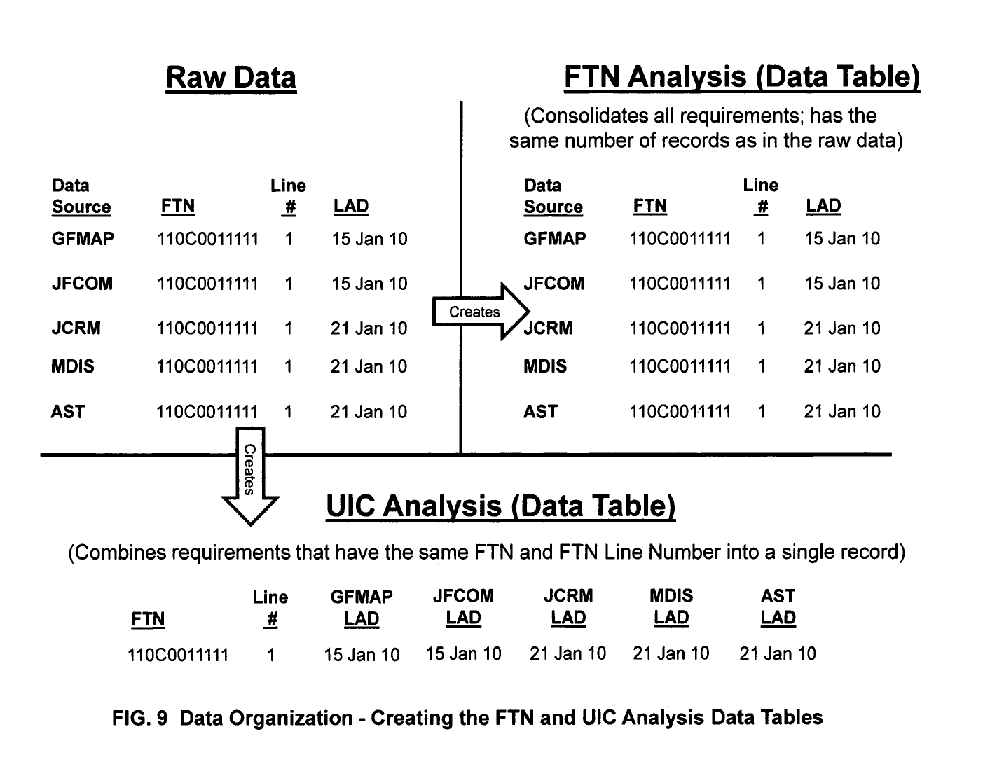

FIG. 9 depicts how the data from the multiple sources is combined within the Master Database 1 to form two separate data tables; the FTN Analysis data table and the UIC Analysis data table. As mentioned before the data from the GFMAP Database 33, JFCOM Database 34, JCRM Database 35, MDIS Database 36, and AST Database 37, are linked to the Master Database 1. The Master Database 1 creates the FTN Analysis data table simply by copying all of the records in the aforementioned databases (33, 34, 35, 36, and 37) and pasting them into a single table called FTN Analysis. As an example, if each of the five data sources had 10,000 records each, the FTN Analysis data table would have 50,000 records. The Master Database 1 creates the UIC Analysis data table by copying all of the records in the aforementioned databases (33, 34, 35, 36, and 37) that have the same FTN and FTN Line Number and pasting them into a single row of data. It continues to do this until all FTNs and FTN Line Numbers are exhausted. This table is called UIC Analysis. As an example, if all five data sources had 10,000 records each (with each record within that database having a unique FTN and FTN Line Number) and the FTNs and FTN Line Numbers all matched within each of those five data sources, the UIC Analysis data table would have 10,000 records.

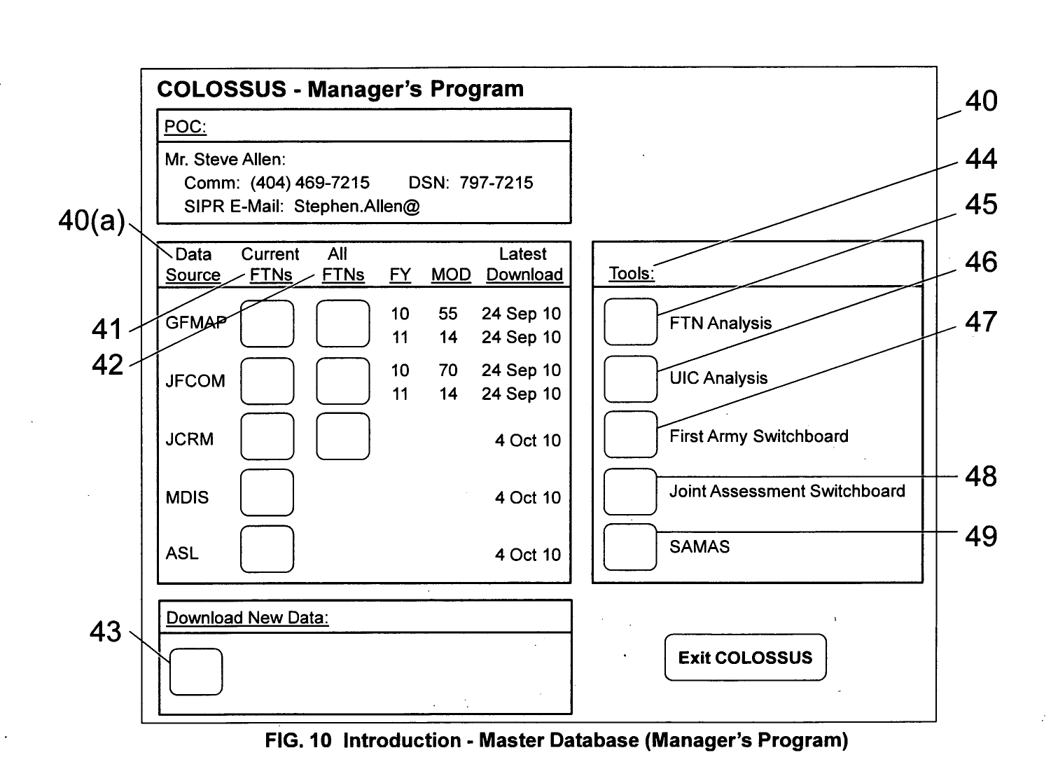

FIG. 10 presents the home page of the COLOSSUS Manager's Program 40, which is derived directly from the Master Database 1. This is the screen first presented when the COLOSSUS program is opened on the desktop or laptop computer 9 of a User 2 who possesses security authorization to access the system. The Data Source panel 40(a) gives the option of selecting links to the respective databases. There are two categories of information available from the external data sources: (1) “Current FTN's,” 41 which will show current, actionable data previously manipulated by the respective database program, and (2) “All FTN's” 42 which displays raw data taken directly from any or all the external data sources. The prompt labeled “Download New Data” 43 takes data from the external data sources and integrates that data into the “FTN Analysis” 45 tool and also the “UIC Analysis” 46 tool.

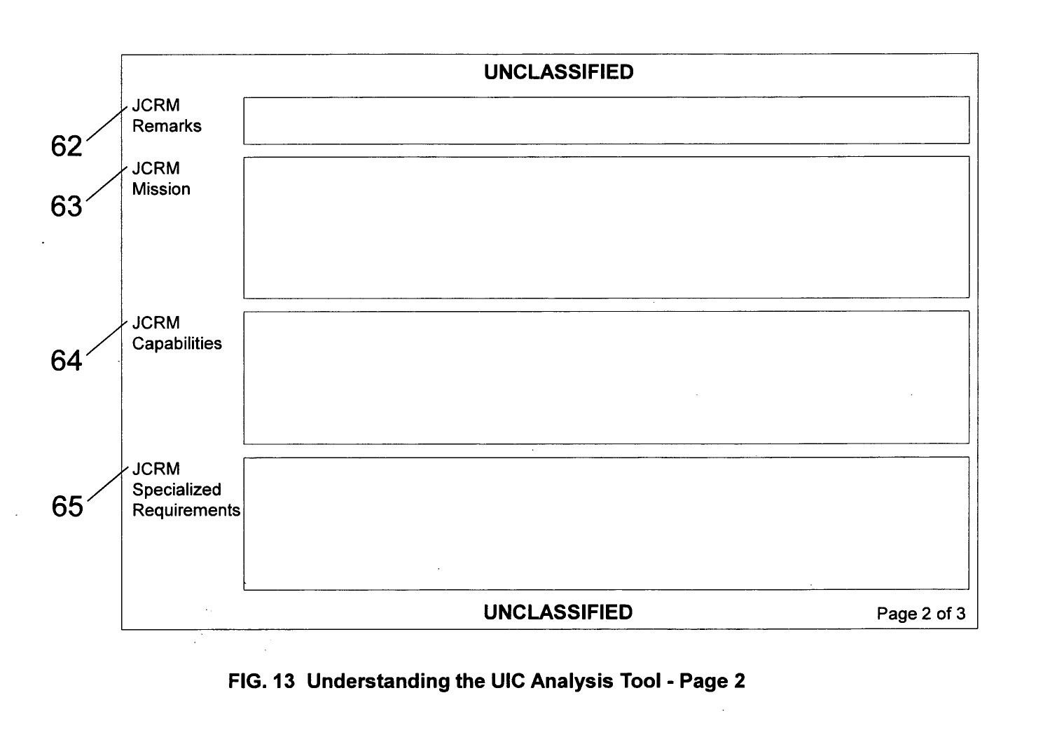

Still referring to FIG. 10, at the “Tools” 44 panel, the User may select the “FTN Analysis” 45 prompt which provides a timeline of historical, present, and future requirements data. Also available is the “UIC Analysis” 46 tool, which provides a snapshot in time of a specific requirement. By way of illustrative example, and not limitation, a “First Army Switchboard” prompt 47 is presented in FIG. 10, which prompt enables tools to support the maintenance of U.S. First Army data. To further emphasize the versatility of the COLOSSUS system, any other numbered U.S. Army component or branch of the U.S. Armed Forces may be made operative at this prompt of the Manager's Program. The “Joint Assessment Switchboard” 48 prompt enables the display of a form, 68, shown in FIG. 13, which provides tools that support the Joint Assessment process and maintain data on units that completed a joint assessment. By selecting the “SAMAS” 49 prompt, the User 2 views an extract of current force structure from the Department of the Army's Structure and Manpower Allocation System (SAMAS) database.

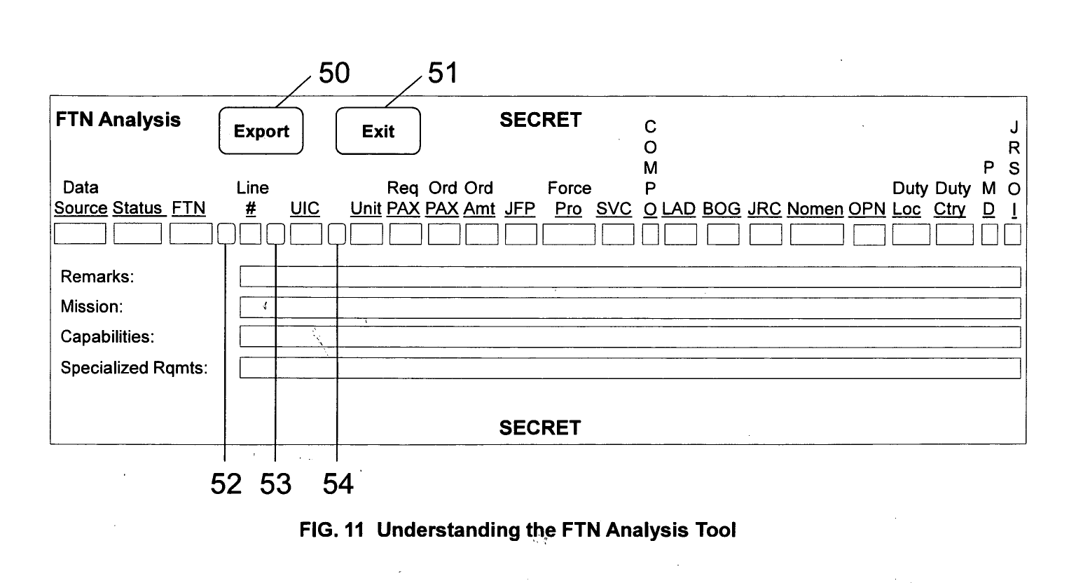

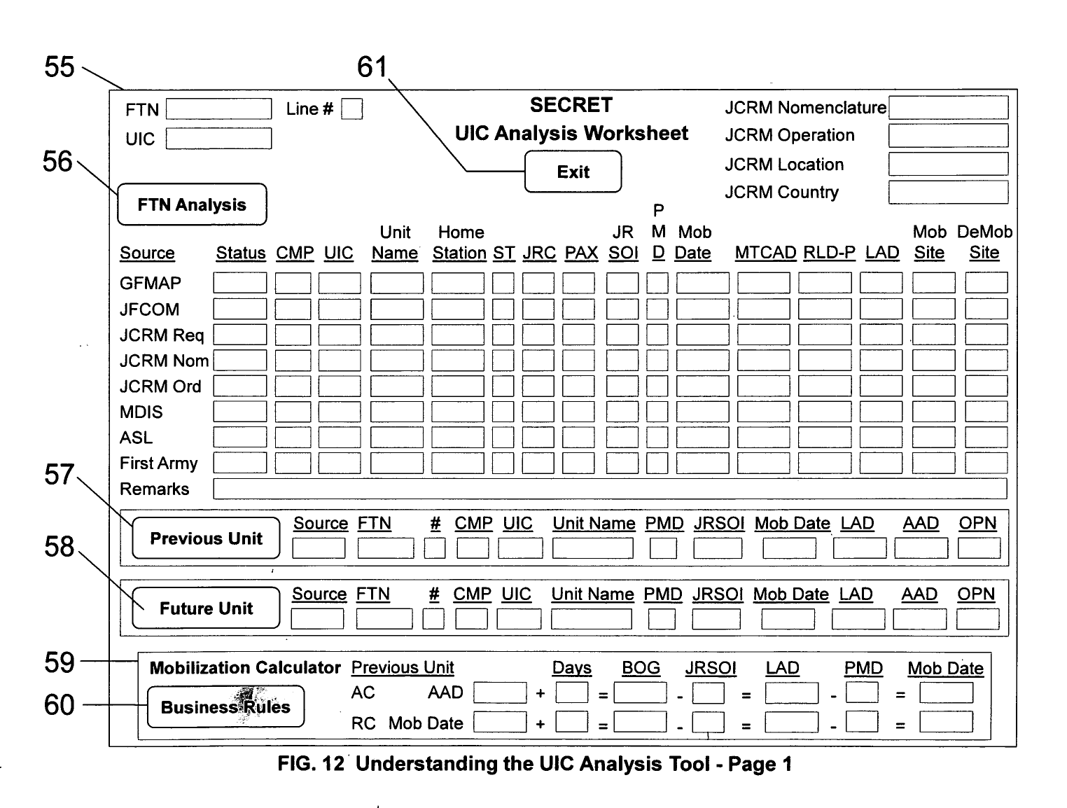

Again viewing FIG. 10, should the User 2 select the “FTN Analysis” prompt 45 on the COLOSSUS Manager's Program 40, a screen entitled “FTN Analysis,” shown in FIG. 11, is displayed. At this screen, the User 2 may click the “Export” 50 prompt, which allows a User 2 to export all records shown into a spreadsheet. The “Exit” 51 prompt takes the User 2 back to the previous screen from which the “FTN Analysis” form was accessed. Buttons 52, 53, and 54 are filters for data that is displayed on a screen entitled “UIC Analysis” shown in FIG. 12. The button 52 to the right of “FTN” filters all records and selects only those that include that 11-digit FTN shown. This is useful when the User 2 desires to view all of the sourcing solutions (or FTN Line Numbers) for a specific FTN. The button 53 to the right of “Line #” filters all records and selects only those that include the full 11-digit FTN and the FTN Line Number shown. This selection always provides a single record. The button 54 to the right of “UIC” when clicked, selects the UIC, which is very useful if the UIC is used for multiple requirements (e.g., a requirement is deleted and the unit is then used for another requirement).

Again referring to FIG. 10, should the “UIC Analysis” 46 tool be selected, the system automatically displays Page 1 of the “UIC Analysis Worksheet,” shown in FIG. 12. Further, by clicking the “FTN Analysis” 56 prompt in FIG. 12, the computer changes screens to the FTN Analysis tool for the FTN and FTN Line Number that are displayed directly above this prompt. An “Identify Previous Unit” 57 prompt enables the User 2 to view a list of units that support the FTN initially displayed on the “UIC Analysis Worksheet.” Once the User 2 selects the preceding unit to this requirement, the system automatically populates the windows to the right of “Identify Previous Unit” 57 and also the Mobilization Calculator” 59 section.

In FIG. 12, should the “Identify Future Unit” 58 prompt be selected, a screen is presented that displays a list of units that support this FTN. Once the User 2 selects the follow-on unit to this requirement, the system automatically populates the windows directly to the right of the “Identify Future Unit” 58 prompt. Selecting the “Business Rules” 60 prompt displays an extract from the CENTCOM business rules. When the “Exit” 61 prompt is clicked, the display in FIG. 12 is closed and the User 2 is returned to the last open form that had been accessed.

FIG. 13 shows an additional form essential to understanding the UIC Analysis Tool, and illustrates Page 2 of the screen that is displayed upon selecting “UIC Analysis” 46 on the Manager's Program 40 shown in FIG. 10. The “JCRM Remarks” 62 panel provides information taken from the “Order CJCS Order Remarks” field in JCRM. The window allows JFCOM Action Officers to provide specific remarks concerning the requirement. A “JCRM Mission” 63 window is provided by the supported COCOM, and identifies the specific mission the requested force will perform during its deployment. The “JCRM Capabilities” 64 window is provided by the supported COCOM, and identifies the capabilities necessary to fulfill the requirement. Also shown on the form is a “JCRM Specialized Requirements” 65, which is also provided by the supported COCOM. This window specifies any special training, equipping, and/or personnel requirements to meet the requested capability.

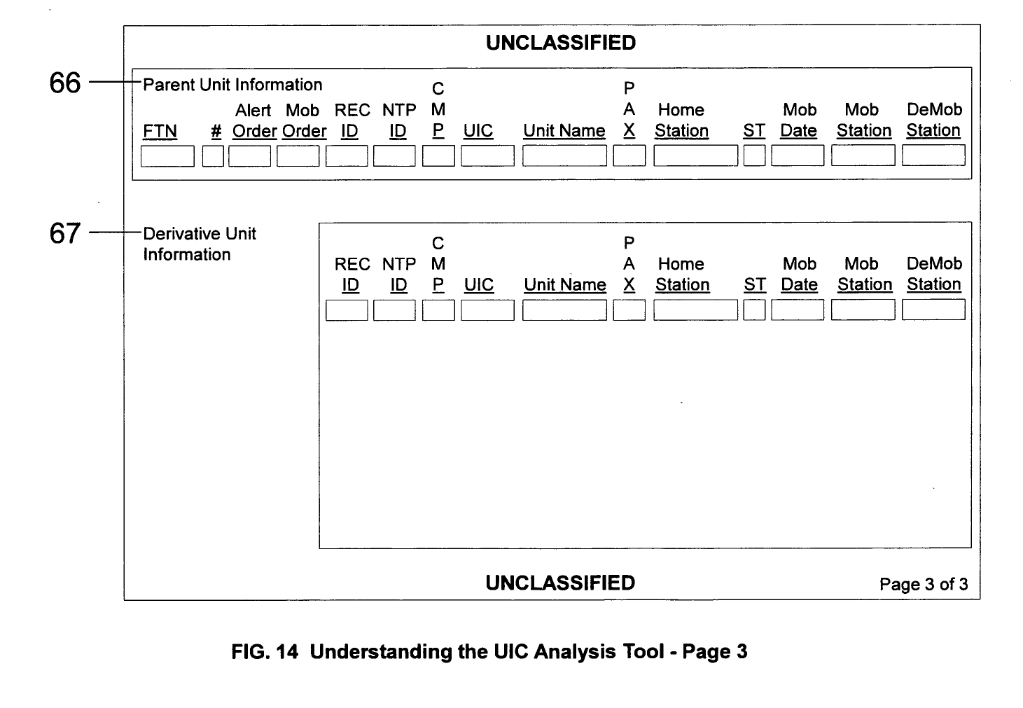

FIG. 14 depicts Page 3 of the screen that is displayed upon selecting “UIC Analysis” 46 on the Manager's Program 40, which is used to effectuate use of the UIC Analysis Tool 46. At the “Parent Unit Information” 66 panel, there is displayed information on the parent unit, which will be the same information as found on the first page of the UIC Analysis Worksheet, as shown in FIG. 12. At the “Derivative Unit Information”67 window, the User 2 will find information on all derivative UICs that are assigned to the parent UIC. It must be noted that these derivative units will not be found in the FTN Analysis Tool, as they have not been assigned against an FTN.

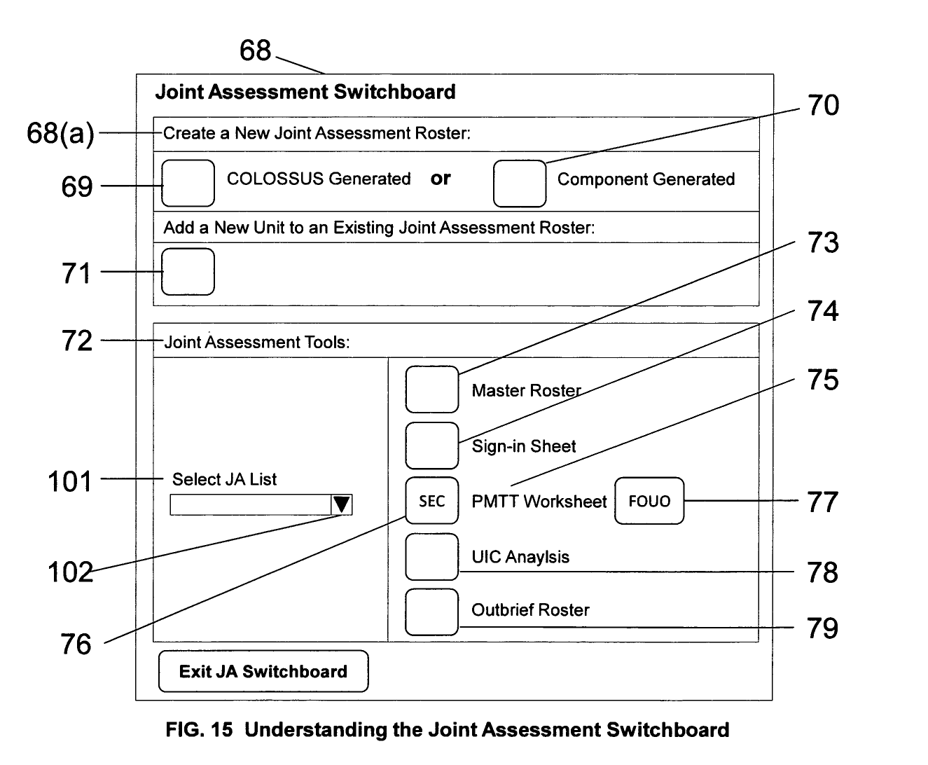

In viewing FIG. 15, there is shown a Colossus computer page entitled “Joint Assessment Switchboard” 68. On this form, a User 2 may use the “Create New Joint Assessment Roster” 68(a) panel to create a new listing of the profiles of military units that will attend a Joint Assessment. The User 2 is given the option of choosing one of two prompts, the “COLOSSUS Generated” 69 button or “Component Generated” 70.

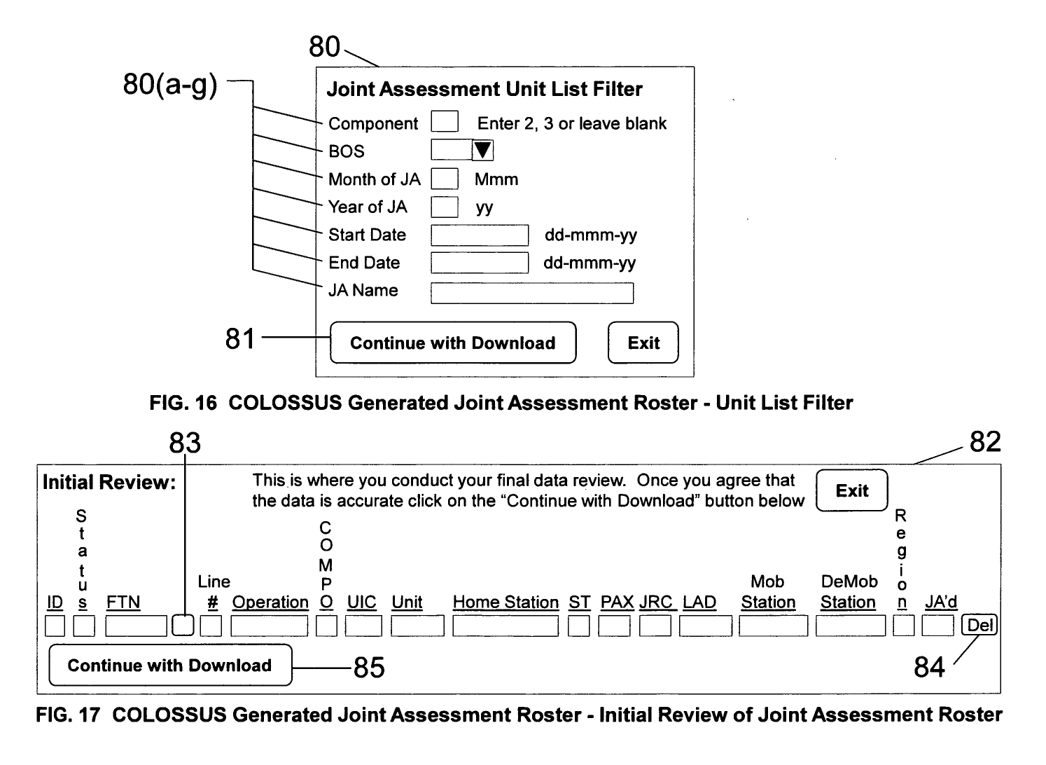

By selecting the “Colossus Generated” 69 button in FIG. 15, a User 2 is prompted to complete two other sequentially-appearing forms, the “Joint Assessment Unit List Filter” 80, shown in FIG. 16, and the “Initial Review” 82 form, shown in FIG. 17. Both these forms require the answering of several criteria-type questions on this type unit and the date window. Upon display of the “Joint Assessment Unit List Filter” 80 form (shown in FIG. 16), the User 2 completes the required information in the small windows 80(a-g). After insertion of the information, the User 2 clicks the “Continue With Download” 81 prompt, which displays an “Initial Review” 82 form. This form 82 allows the User 2 to view the list generated from the input provided in the “Joint Assessment Unit List Filter” 80 form. The “Initial Review” 82 form also allows the User 2 to (1) view all of the requirements for that particular FTN when the “Status FTN” 83 button is clicked, and (2) delete requirements that will not go through the Joint Assessment (by clicking the “Del” 84 button on the far right of the form). The User 2 may then click “Continue With Download” 85 to complete the download process and to return to the “Joint Assessment Switchboard” 68.

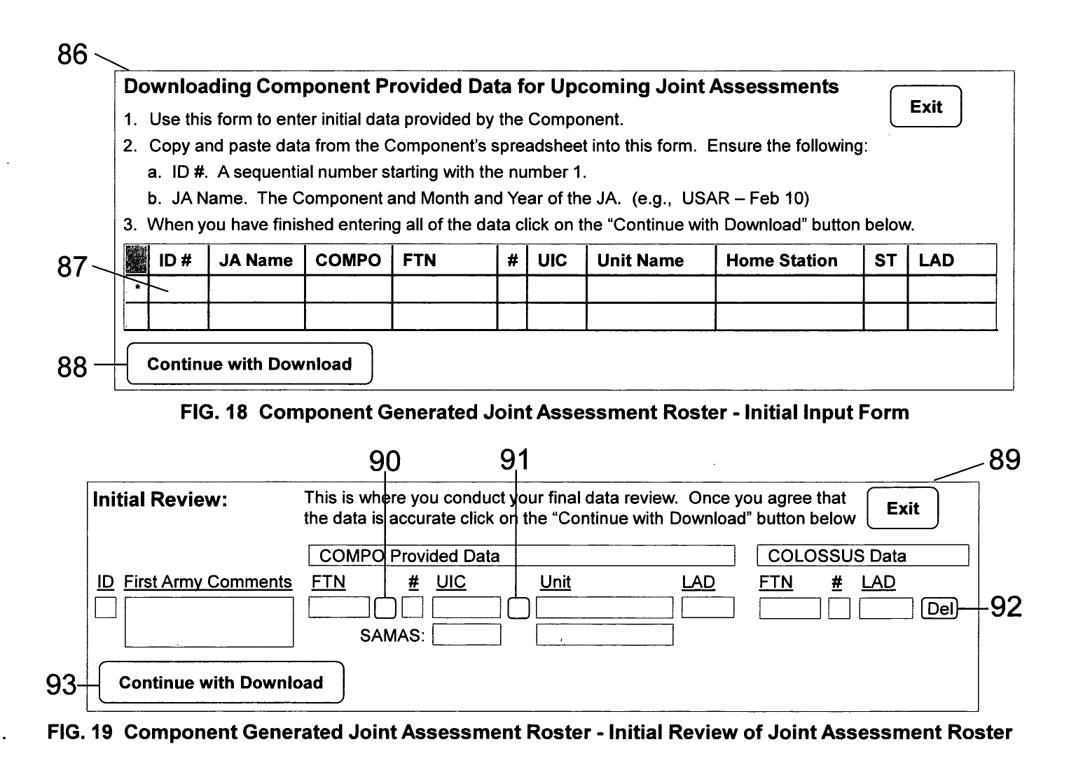

Again referring to FIG. 15, by selecting the “Component Generated” 70 button, the User 2, provides the proposed unit attendance roster. COLOSSUS then goes through several steps to validate the Component roster. After selecting “Component Generated” 70, two sequentially-appearing forms are displayed, the first of which is entitled “Downloading Component-Provided Data” 86, shown in FIG. 18. Here, the User 2 inputs the necessary information in the window 87 displayed. Once finished, the User 2 then clicks “Continue With Download” 88, which takes the User 2 to another “Initial Review”89 form, shown in FIG. 19, which internally compares the data input for the “Downloading Component-Provided Data” 86 form with the data that is stored in the COLOSSUS, or Master Database 1. At this point, COLOSSUS can identify data errors and allow the User 2 to make recommended corrections.

The “Initial Review” 89 form also permits the User 2 to (1) look at all the requirements for that particular FTN, by clicking the “COMPO FTN” button 90, (2) view the Unit Identification Code (UIC) and unit name information by clicking the “UIC-Unit” button 91, and (3) delete requirements that will not go through the Joint Assessments, when the “Del” prompt 92 is clicked. The User 2 may then click “Continue With Download” 93 to complete the download process and return to the “Joint Assessment Switchboard” 68.

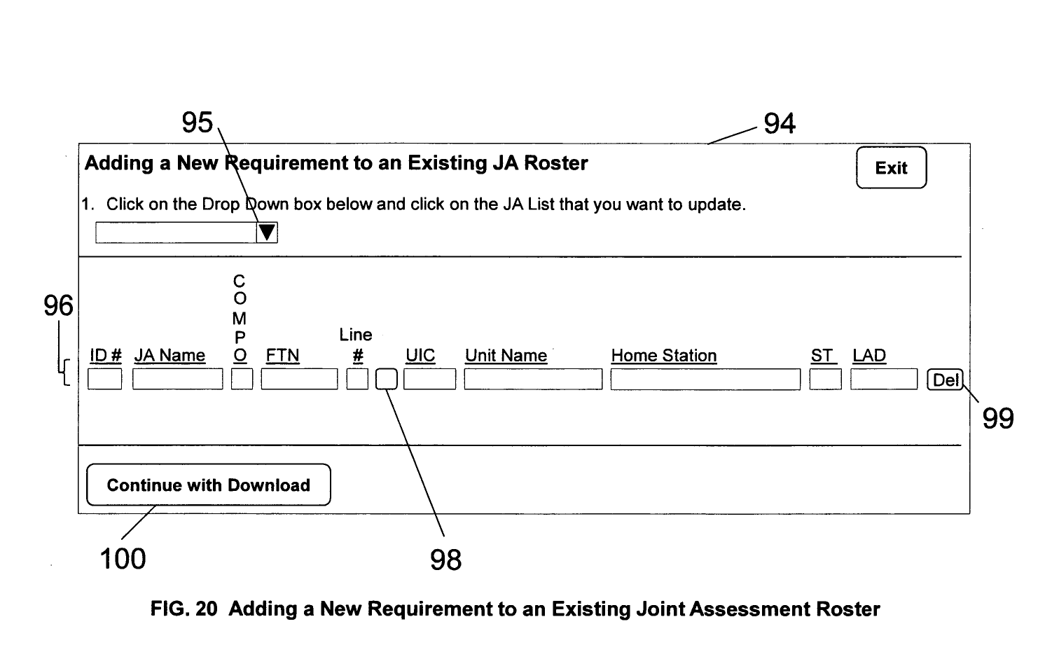

Returning to FIG. 15, an examination is made of other features of the “Joint Assessment Switchboard” 68. Another available option is the “Add a New Unit to an Existing Joint Assessment Roster” 71 button. By selecting this prompt, two additional screens, or forms, may be displayed, the first to appear being “Adding a New Requirement to an Existing JA Roster” 94, shown in FIG. 20. The first step is for the User 2 to click on the arrow in the “Drop Down” box 95. This will display choices available to identify the Joint Assessment Roster to which the unit will be added. The User 2 must then continue to fill in the remaining information 96 in the horizontal windows of this form. The “Adding a New Requirement to an Existing JA Roster” 94 screen (FIG. 20) also allows the User to (1) view of all the requirements for that particular FTN, by clicking a prompt 98 under the “Line #” text, and (2) delete requirements, by selecting the “D” prompt 99 on the far right side of the screen.

Once the User 2 has entered all required data on the “Adding a New Requirement to an Existing JA Roster” 94 form, the “Continue with Download” 100 prompt is clicked, which will display the “Initial Review” 89 form, shown in FIG. 19. Similar to the earlier discussion, the “Initial Review” 89 form internally compares data that the User 2 entered in the “Adding a New Requirement to an Existing JA Roster” 94 screen against the data that is stored in the COLOSSUS Master Database 1. The User 2 may then make recommended corrections. This “Initial Review” 89 form also permits the User 2 to (1) look at all the requirements for that particular FTN, by clicking the “COMPO FTN” button 90, (2) view the Unit Identification Code (UIC) and unit name information by clicking the “UIC-Unit” button 91, and (3) delete requirements that will not go through the Joint Assessments, when the “Del” prompt 92 is clicked. The User may then click “Continue With Download” 93 to complete the update process and return to the “Joint Assessment Switchboard” 68.

Referring again to FIG. 15, the “Joint Assessment Switchboard” 68, there are several “Joint Assessment Tools” 72 that are available to the User 2. To begin, the User 2 must click on the drop down arrow 101 of the “Select JA List” window 102. This will enable the selection of the Joint Assessment Roster that the User 2 wishes to work with. Next, the User 2 may select any of the “Joint Assessment Tools” 72, which function, respectively, as follows:

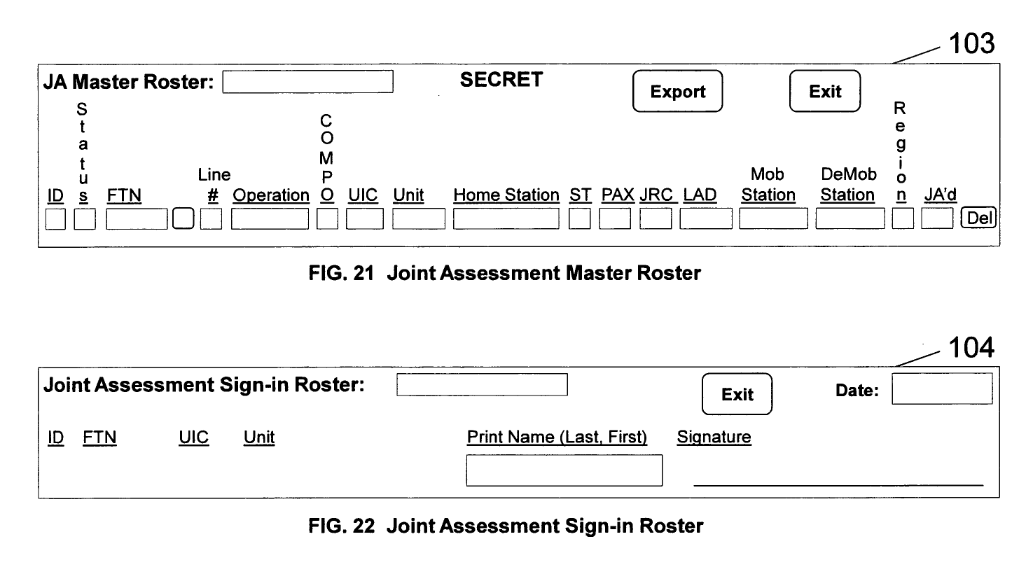

“Master Roster” 73 displays the “JA Master Roster” 103, shown in FIG. 21, which comprises a list of units that should attend the Joint Assessment Workshop;

“Sign-in Sheet” 74, will display the “Joint Assessment Sign-in Roster” 104, shown in FIG. 22, comprising a recordation of unit attendance at the Joint Assessment Workshop;

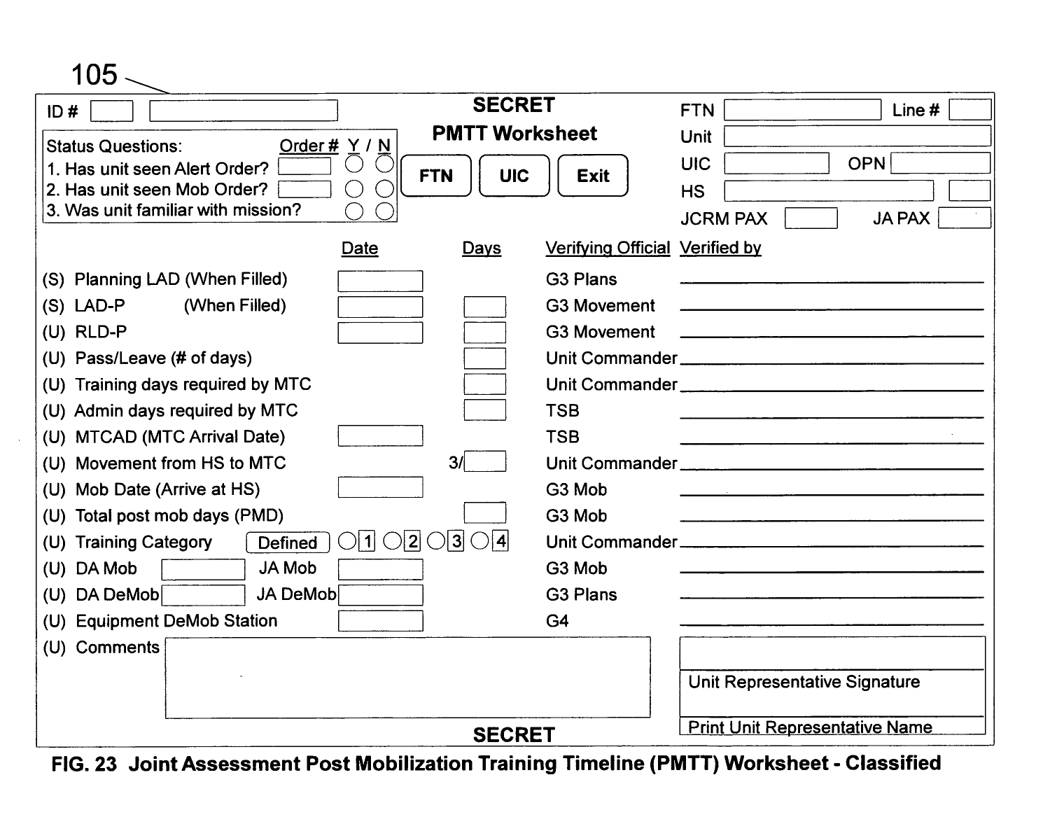

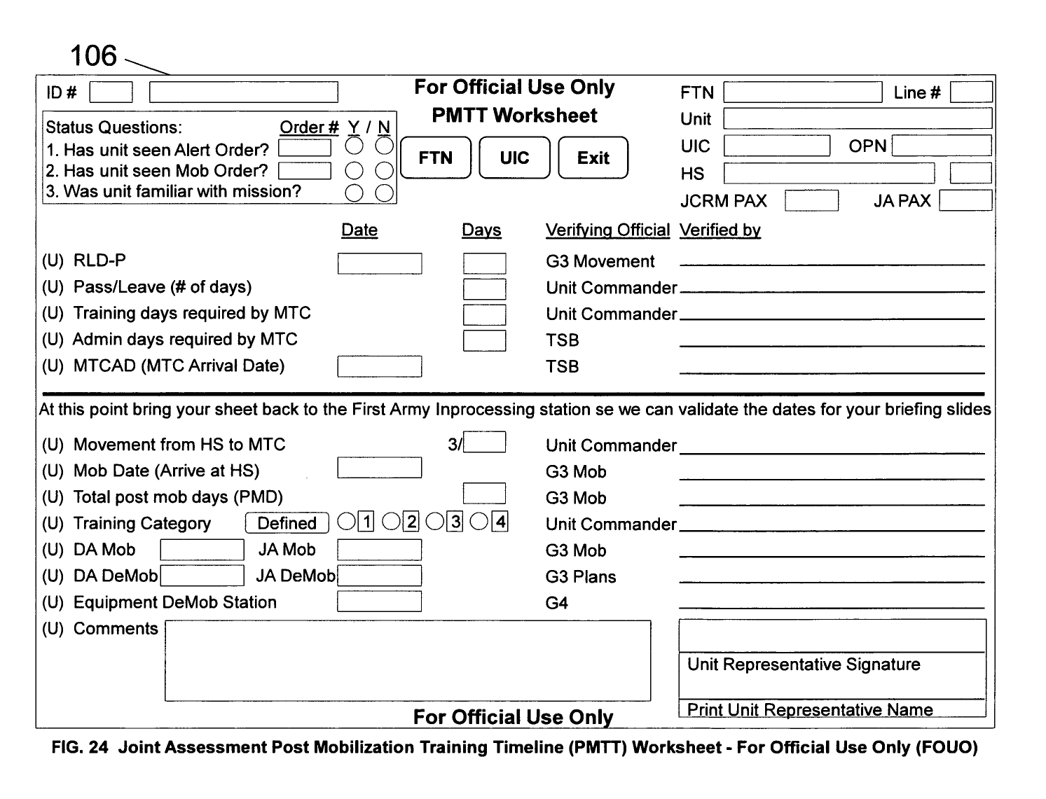

The “PMTT Worksheet” panel comprises a Joint Assessment Worksheet which is used as a contract between the unit and the First Army, (or any numbered U.S. Field Army which utilizes the COLOSSUS system). This panel provides the means to calculate and validate the unit's mobilization data. The two optional prompts are (1) “Secret” 76 which will display a “Secret PMTT Worksheet” 105, shown in FIGS. 23, and (2) “FOUO” 77 (“for official use only”) which displays a “FOUO PMTT Worksheet” 106, shown in FIG. 24. The “Secret PMTT Worksheet” 105 is maintained by the Joint Assessment team, while the “FOUO PMTT Worksheet” 106 is issued to the unit at the start of the Joint Assessment.

“UIC Analysis” 78, will display the “UTC Analysis” 55 shown in FIG. 12

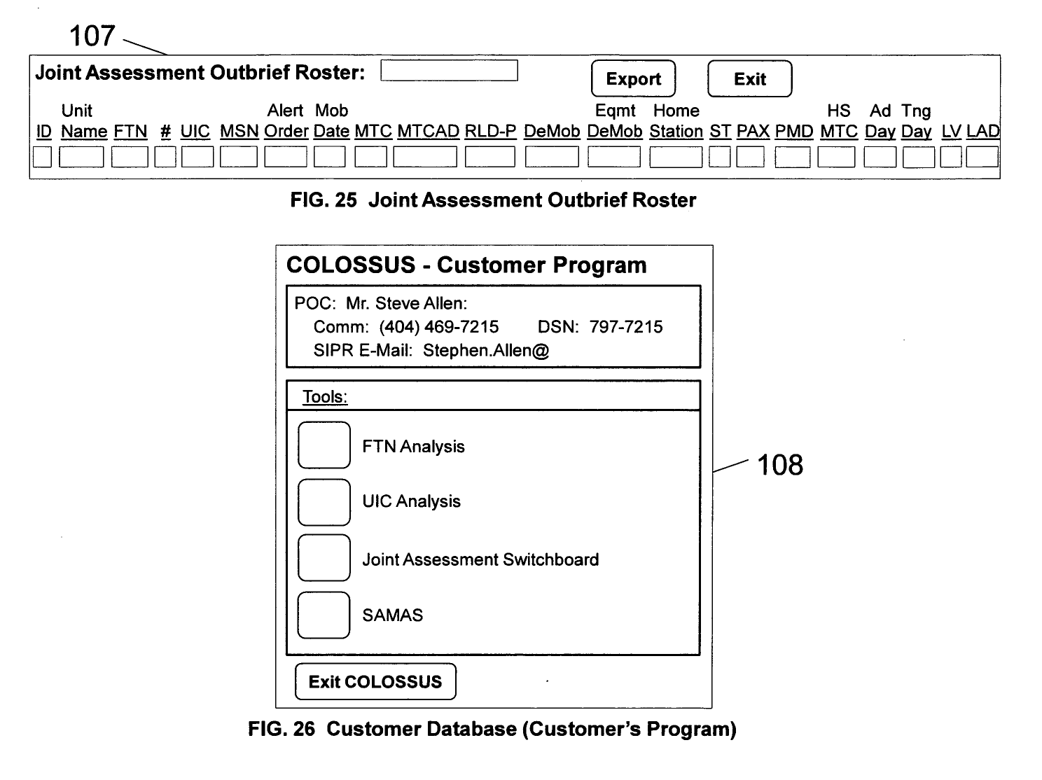

“Outbrief Roster” 79, will display the “Joint Assessment Outbrief Roster” 107, shown in FIG. 25, which is used by the senior First Army representative at the Joint Assessment outbrief to follow the attending unit briefings and ensure they are briefing the same information that was collected/disseminated during the Joint Assessment process.

FIG. 26 depicts the COLOSSUS Customer Program 108, which enables a customer to view data relative to the FTN Analysis, UIC Analysis, Joint Assessment Switchboard, and SAMAS.

While preferred embodiments of the present inventive concept have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

What is claimed is

1. a system for planning the consolidation of U.S. military unit and individual requirements in order to effect the mobilization, training, validation and/or deployment of at least one military unit, the system comprising
(a) a first computer having a browser suitable for gathering various items of raw data stored on diverse military electronic databases;
(b) a relational database management system (RDBMS) capable of storing said raw data accessed by said computer system;
(c) a series of computing modules arranged so as to communicate with, and gather classified and un-classified raw data from designated U.S. military websites;
(d) a spreadsheet application featuring, minimally, calculation, graphing tools, pivot tables, and a macro programming language to reformat said raw data obtained from each website source into a compatible format recognizable by the RDBMS; and
(e) a computer-readable medium having storage capabilities and instructions that enable the end User of a second computer to access said reformatted raw data.

2. A method utilized on a programmed computer system having a browser, for gathering various items of raw data stored on diverse military electronic databases, said raw data to be applied in planning the consolidation of U.S. military unit and individual requirements in order to effect the mobilization, training, validation and/or deployment of at least one military unit, comprising
(a) maintaining, in said programmed computer system, a relational database management system (RDBMS) capable of storing said raw data accessed by said computer system;
(b) accessing, by use of servers equipped with military security clearance software, a plurality of websites in order to download raw data from each such website;
(c) using a spreadsheet application featuring calculation, graphing tools, pivot tables, and a macro programming language to reformat said raw data obtained from each website source into a compatible format recognizable by the RDBMS;
(d) manipulating, by use of the RDBMS, the reformatted data specifically to screen said reformatted data for errors;
(e) selecting the most current, actionable reformatted data for presentation to selected military command and staff personnel;
(f) integrating said reformatted data from each website into a single RDBMS database program; and
(g) providing said reformatted data in a plurality of computer-readable mediums, each medium customized to the requirements of a specified end User.

3. A method utilized on a programmed computer system having a browser, for acquiring various items of raw data stored on the interne websites of GFMAP, JFCOM, JCRM, MIDIS, and AST, said raw data to be applied in planning the consolidation of U.S. military unit and individual requirements in order to effect the mobilization, training, validation and/or deployment of at least one subordinate unit of the U.S. Army Forces Command comprising
(a) maintaining, in said programmed computer system, a relational database management system (RDBMS) capable of storing said raw data accessed by said computer system;
(b) accessing, by use of servers equipped with military security clearance software, a plurality of websites in order to download raw data from each such website;
(c) using a spreadsheet application featuring calculation, graphing tools, pivot tables, and a macro programming language to reformat said raw data obtained from each website source into a compatible format recognizable by the RDBMS;
(d) manipulating, by use of the RDBMS, the reformatted data specifically to screen said reformatted data for errors;
(e) storing said reformatted data into a Master Database;
(f) selecting the most current, actionable reformatted data for presentation to selected military command and staff personnel of said U.S. First Army;
(g) integrating said reformatted data from each said website into a single RDBMS database program; and
(h) providing said reformatted data in a plurality of computer-readable mediums, each medium customized to the requirements of authorized personnel of a specified end User.

4. A method as in claim 3, wherein said programmed computer system is applied for acquiring various items of raw data stored on the internet websites of GFMAP, JFCOM, JCRM, MDIS, and the U.S. Army Central, said raw data to be applied in planning the consolidation of U.S. military unit and individual requirements in order to effect the mobilization, training, validation and/or deployment of at least one subordinate unit of said U.S. Army Central, and further comprising, as substitution for sub-step (f), selecting the most current, actionable reformatted data for presentation to selected military command and staff personnel of said U.S. Army Central.

5. A method/system as in claim 3, wherein said programmed computer system is applied for acquiring various items of raw data stored on the internet websites of GFMAP, JFCOM, JCRM, MDIS, and the U.S. Army North, said raw data to be applied in planning the consolidation of U.S. military unit and individual requirements in order to effect the mobilization, training, validation and/or deployment of at least one subordinate unit of said U.S. Army North, and further comprising, as substitution for sub-step (f), selecting the most current, actionable reformatted data for presentation to selected military command and staff personnel of said U.S. Army North.

6. A method/system as in claim 3, wherein said programmed computer system is applied for acquiring various items of raw data stored on the internet websites of GFMAP, JFCOM, JCRM, MDIS, and the U.S. Army Europe, said raw data to be applied in planning the consolidation of U.S. military unit and individual requirements in order to effect the mobilization, training, validation and/or deployment of at least one subordinate unit of said U.S. Army Europe, and further comprising, as substitution for sub-step (f), selecting the most current, actionable reformatted data for presentation to selected military command and staff personnel of said U.S. Army Europe.

7. A method/system as in claim 3, wherein said programmed computer system is applied for acquiring various items of raw data stored on the internet websites of GFMAP, JFCOM, JCRM, MDIS, and the U.S. Army Pacific, said raw data to be applied in planning the consolidation of U.S. military unit and individual requirements in order to effect the mobilization, training, validation and/or deployment of at least one subordinate unit of said U.S. Army Pacific, and further comprising, as substitution for sub-step (f), selecting the most current, actionable reformatted data for presentation to selected military command and staff personnel of said U.S. Army -Pacific.

8. A method/system as in claim 3, wherein said programmed computer system is applied for acquiring various items of raw data stored on the interne websites of GFMAP, JFCOM, JCRM, MDIS, and the U.S. Army Africa, said raw data to be applied in planning the consolidation of U.S. military unit and individual requirements in order to effect the mobilization, training, validation and/or deployment of at least one subordinate unit of said U.S. Army Africa, and further comprising, as substitution for sub-step (f), selecting the most current, actionable reformatted data for presentation to selected military command and staff personnel of said U.S. Army Africa.

9. A method/system as in claim 3, wherein said programmed computer system is applied for acquiring various items of raw data stored on the internet websites of GFMAP, JFCOM, JCRM, MDIS, AST, and any one of a group consisting of the U.S. Air Force, the U.S. Navy, The U.S. Marine Corps, the U.S. Army National Guard, and the U.S. Army Reserve, said raw data to be applied in planning the consolidation of U.S. military unit and individual requirements in order to effect the mobilization, training, validation and/or deployment of at least one subordinate unit within any of aforesaid group, and further comprising, as substitution for sub-step (f), selecting the most current, actionable reformatted data for presentation to selected military command and staff personnel of said armed force.
